(19) United States
(12) Patent Application Publication
(10) Pub. No.: US 2013/0001443 A1
(43) Pub. Date: Jan. 3, 2013

(54) APPARATUS FOR GENERATING ELECTRON BEAMS, AND METHOD FOR MANUFACTURING SAME

(75) Inventors: Yong Woon Park, Gyeongbuk (KR); In Soo Ko, Gyeongbuk (KR); Sung Ju Park, Gyeongbuk (KR); Yong Jeong Park, Gyeongbuk (KR); Seung Hwan Kim, Gyeongbuk (KR); Ju Ho Hong, Gyeongbuk (KR); Sung Ik Moon, Jeollanam-do (KR)

(73) Assignee: POSTECH ACADEMY-INDUSTRY FOUNDATION, Gyeongbuk (KR)

(21) Appl. No.: 13/634,071

(22) PCT Filed: Mar. 11, 2011
(86) PCT No.: PCT/KR2011/001720

§ 371 Date: Sep. 11, 2012

(30) Foreign Application Priority Data
Mar. 11, 2010 (KR) 10-2010-0021697

(51) Int. Cl. H01J 9/26; G21K 5/00

(52) U.S. Cl. 250/493.1; 29/593

(57) ABSTRACT

The present invention relates to an apparatus for generating an electron beam, comprising: a cathode; a housing which has an opening formed at one side thereof such that the cathode is coupled to the opening, and which has a resonant cavity formed therein; and a gasket interposed between the cathode and the housing such that the gasket is compressed in accordance with the coupling strength between the cathode and the housing so as to shut off the resonant cavity from the outside.

### BACKGROUND OF THE INVENTION

1. Field of the Invention

The present invention relates to an apparatus for generating an electron beam and a method of manufacturing the same.

2. Discussion of the Related Art

As science and technology are advanced, an electron gun is used in order to understand the chemical or physical characteristics of an object in the modern science.

An electron gun generates electrons in a thin beam form. The electron gun is used in an electron microscope, a travelling wave tube, and a cathode-ray tube and is also included in a cyclotron in order to understand the characteristics of an object.

In order to emit an electron beam, the laser beam may be made incident on a cathode. A method using a resonant cavity on which a radio frequency is incident is used as means for accelerating the emitted electron beam.

### SUMMARY OF THE INVENTION

A conventional electron gun used in a particle accelerator has some problems the coupling structure of a cathode and a housing. One of the problems is that it is difficult to form high vacuum in the resonant cavity of the housing. Furthermore, the conventional electron gun is problematic in that it is very difficult to prevent a dark current generated in the resonant cavity. Furthermore, the conventional electron gun is problematic in that it is difficult to precisely control the resonant frequency of the resonant cavity.

An object of the present invention is to solve the problems, and technical objects of the present invention are not limited to the above-described object and other technical objects that have not been described above will become evident to those skilled in the art from the following description

In order to achieve the object, an apparatus for generating an electron beam according to the present invention includes a housing configured to have a resonant cavity formed therein; a cathode installed in the opening of the housing on one side so that an electron beam is generated from a surface of the cathode by a laser incident on an inside of the resonant cavity; and a metal gasket installed between the cathode and the housing in order to seal the housing and compressed by coupling strength between the cathode and the housing so that the resonant frequency of the resonant cavity is controlled.

Furthermore, the metal gasket may be made of oxygen-free copper.

Furthermore, the metal gasket may be fabricated by cutting a metal plate in a ring form or fabricated in a ring form using a casting or forging method.

Furthermore, the resonant cavity may include a first resonant cavity and a second resonant cavity connected together, and the first resonant cavity and the second resonant cavity may be arranged in a direction where the electron beam generated from the cathode is emitted.

In order to achieve the object, a method of manufacturing an apparatus for generating an electron beam according to the present invention includes combining a housing having a resonant cavity formed therein, a metal gasket, and a cathode; measuring the resonant frequency of the resonant cavity of the housing with which the metal gasket and the cathode are combined; and further compressing the metal gasket or replacing the metal gasket with another metal gasket having a different thickness if the measured resonant frequency is not identical with a set value.

In order to achieve the object, a method of manufacturing an apparatus for generating an electron beam according to the present invention includes a metal gasket between a cathode and a housing while combining the cathode and the housing; measuring the resonant frequency of a resonant cavity within the housing; and further compressing the metal gasket by increasing coupling strength of the cathode and the housing, if the measured resonant frequency is less than a set value, and replacing the metal gasket with another metal gasket having a thicker thickness, if the measured resonant frequency is greater than the set value.

In order to achieve the object, a method of manufacturing an apparatus for generating an electron beam according to the present invention, including a housing configured to have a resonant cavity formed therein, a cathode installed in an opening of the housing on one side, and a metal gasket installed between the cathode and the housing, wherein the resonant cavity comprises a first resonant cavity and a second resonant cavity connected together, the method includes measuring the resonant frequencies of the first resonant cavity and the second resonant cavity; changing a volume of the first resonant cavity by compressing or extending the housing in order to control the resonant frequency of the first resonant cavity; and further compressing the metal gasket or replacing the metal gasket with another metal gasket having a different thickness in order to control the resonant frequency of the second resonant cavity.

Furthermore, the metal gasket may be provided by cutting a metal plate in a ring form or provided in a ring form using a casting or forging method.

In order to achieve the object, a method of manufacturing an apparatus for generating an electron beam according to the present invention includes measuring the resonant frequency of a resonant cavity within a housing and deforming the housing by compressing or extending the housing in an axial direction if the measured resonant frequency is not identical with a set value.

### BRIEF DESCRIPTION OF THE DRAWINGS

FIG. 1 shows the arrangement of a simulation apparatus for an apparatus for generating an electron beam according to an embodiment of the present invention;

FIG. 2 is an exploded perspective view of the apparatus for generating an electron beam according to an embodiment of the present invention;

FIG. 3 is a cross-sectional view of an apparatus for generating an electron beam according to an embodiment of the present invention;

FIG. 4 is a flowchart illustrating a method of tuning a resonant frequency according to an embodiment of the present invention;

FIG. 5 is the results of simulation for a distribution of electric fields within the resonant cavity of the apparatus for generating an electron beam according to an embodiment of the present invention;

FIG. 6 is a side cross-sectional view showing a process of tuning a resonant frequency in a first resonant cavity and a second resonant cavity according to an embodiment of the present invention;

FIG. 7 is a graph showing experimental data and the results of simulation according to an embodiment of the present invention; and

FIG. 8 is a flowchart illustrating a process of tuning a resonant frequency according to another embodiment of the present invention.

### DETAILED DESCRIPTION OF THE EMBODIMENTS

Hereinafter, embodiments of the present invention will be described in detail with reference to the accompanying drawings. However, the present embodiments are not limited to the disclosed embodiments, but may be implemented in various ways. The present embodiments are provided to complete the disclosure of the present invention and to allow those having ordinary skill in the art to fully understand the scope of the present invention. The shapes of elements in the drawings may be enlarged in order to highlight a clearer description, and the same reference numbers are used throughout the drawings to refer to the same parts.

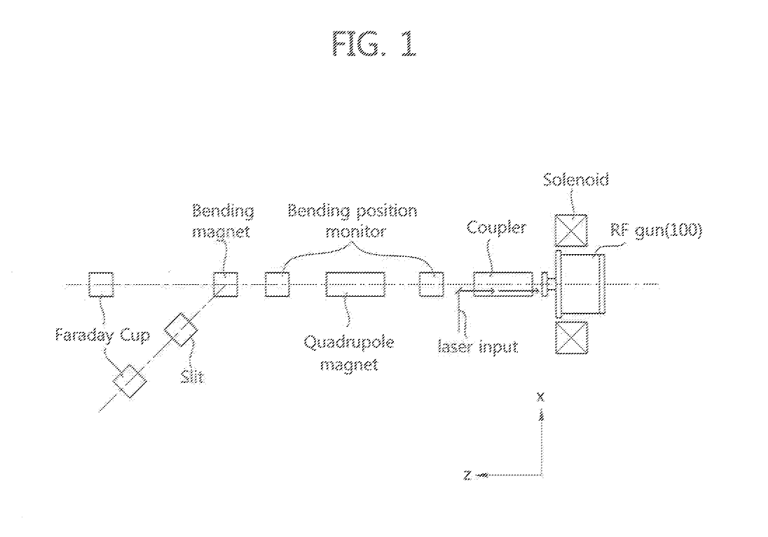

FIG. 1 shows the arrangement of a simulation apparatus for an apparatus for generating an electron beam according to an embodiment of the present invention.

As shown in FIG. 1, a laser may be introduced from the front of a Radio Frequency (RF) gun 100, that is, an apparatus for generating an electron beam, to the inside, and the laser collides against a cathode within the radio frequency gun, thereby generating an electron beam.

The generated electron beam is discharged outside the radio frequency gun. The discharged electron beam is converged by a solenoid on the outside and accelerated while passing through an acceleration column.

In order to remove an increase of emittance due to space charges, a solenoid and a booster linear accelerator may be used. The discharged electron beam may pass through a bending position monitor for monitoring the position of the electron beam and a quadruple magnet. Next, the electron beam may reach a Faraday cup after passing through a bending magnet. An increment of emittance under this simulation condition may be calculated by a mathematic simulation program PARMELA.

In researches into a photocathode RF gun, a major interest is high quantum efficiency and low emittance. From a viewpoint of quantum efficiency, researches have long been carried on substance suitable for the material of a cathode.

In the prior art, in order to form vacuum within a resonant cavity and preclude the leakage of a radio frequency within the resonant cavity, a helicoflex seal was installed between the housing of the resonant cavity and the cathode. It was however found that the helicoflex seal forms a fine gap between the cathode and the housing. It was also found that the gap generates a RF breakdown of the resonant cavity and a dark current.

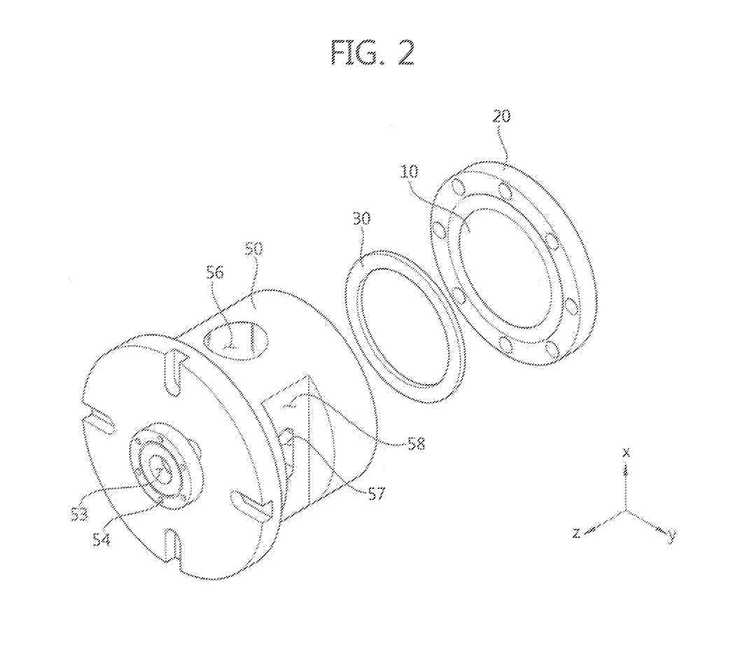

FIG. 2 is an exploded perspective view of an apparatus for generating an electron beam according to an embodiment of the present invention.

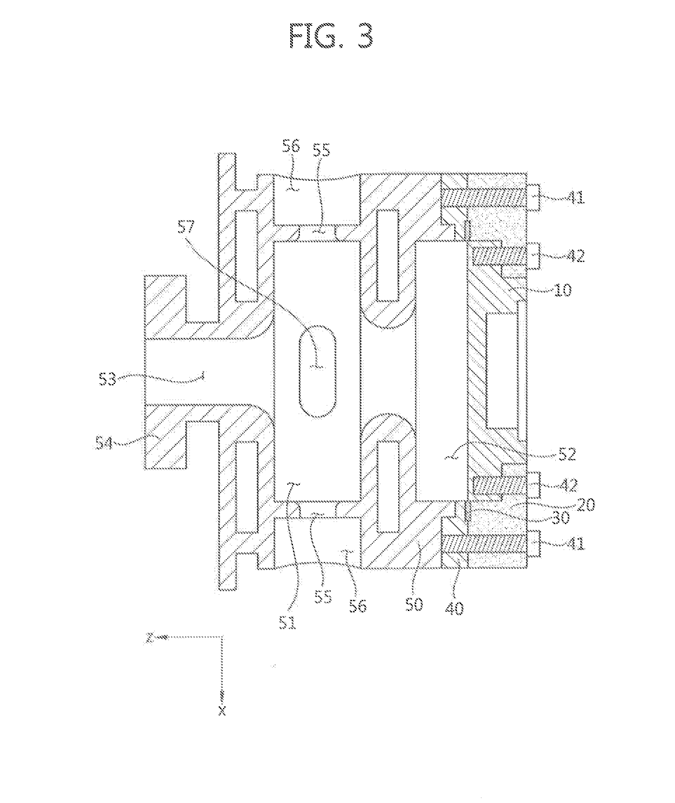

FIG. 3 is a cross-sectional view of the apparatus for generating an electron beam according to an embodiment of the present invention.

As can be seen from FIGS. 2 and 3, the apparatus for generating an electron beam according to the present invention includes a housing 50, a gasket 30, and a cathode 10. The housing 50 may have a first resonant cavity (full cell) 51 and a second resonant cavity (half cell) 52 provided therein. The housing 50 may be made of copper and may be made of, in particular, oxygen-free copper. As another embodiment, one resonant cavity may be provided inside the housing and two or more resonant cavities may be provided inside the housing.

An electron beam discharge hole 53 may be provided on one side of the housing 50 in a z-axis direction. The electron beam discharge hole 53 is a passage through which an electron beam generated from the cathode 10 is discharged to the outside. An electron beam discharge tube flange 54 may be provided in the outer circumference of the electron beam discharge hole 53 and may be connected to an external tube.

A pumping cavity 56 is a part connected to vacuum pump (not shown) in order to maintain the degree of vacuum within the first resonant cavity 51 and the second resonant cavity 52. A pumping hole 55 is provided so that the first resonant cavity 51 and the pumping cavity 56 communicate with each other.

A wave guide seating unit 58 is a part where a wave guide (not shown) is installed. The wave guide seating unit 58 may transfer externally generated electromagnetic waves to the first resonant cavity 51 through the wave guide.

A housing flange 40 is joined on the second resonant cavity (52) side of the housing 50 and may be integrated with the housing 50. The housing flange 40 may be made of stainless steel having higher strength than copper.

The cathode 10 is a part that generates an electron beam when a laser beam incident on the resonant cavity collides against the cathode. The cathode 10 may be made of copper and may be made of, in particular, oxygen-free copper. A cathode flange 20 may be coupled to the cathode 10 by bolts 42. As an alternative, the cathode flange and the cathode may be combined together by brazing. The cathode flange 20 combined with the cathode 10 may combined with the housing flange 40 by bolts 41. The cathode flange 20 may be made of stainless steel having greater strength than copper.

The gasket 30 is installed between the housing flange 40 and the cathode flange 20. The gasket 30 may seal the inside of the resonant cavity, thus being capable of maintaining vacuum. The gasket 30 may be made of metal and may be made of, in particular, oxygen-free copper. When the gasket is made of copper, there is an advantage in that RF contact is increased. The gasket 30 may be formed by cutting a gasket form in a ring form in a copper steel plate or may be formed in a ring form using a casting or forging method.

When the cathode flange 20 is combined with the housing flange 40 by the bolts, the gasket 30 may be finely deformed and compressed by coupling strength.

As another embodiment, a knife edge (or protrusion) may be provided in a surface where the cathode flange and the housing flange come in contact with the gasket. Thus, when the coupling strength is applied between the cathode flange and the housing flange, the knife edge is minutely dug into the gasket, and thus an interval between the cathode flange and the housing flange may be reduced.

According to experiments, it was found that when coupling strength was applied to the extent that the gasket 30 was compressed about 50 μm, the housing could be sealed against the outside to the extent that vacuum within the resonant cavity might be maintained. However, the degree of compression may differ depending on the size of the gasket, the housing, and the cathode or experiment conditions.

The gasket used in the present embodiment had a diameter was about 10 cm, a thickness was about 1 mm, the degree of vacuum of the resonant cavity was about 10⁻¹⁰ Torr, and a resonant frequency was set to 2.856 GHz.

After the gasket 30 was compressed about 50 μm as described above, if the coupling strength was further increased, the gasket 30 could be further compressed about 200 μm. However, the degree of compression may differ depending on the size of the gasket, the housing, and the cathode or experiment conditions. The volume of the resonant cavity may be minutely controlled by this compression, and thus the resonant frequency of the resonant cavity may be controlled. According to the construction of this gasket, there is an advantage in that a high vacuum state may be easily formed in the resonant cavity.

Furthermore, a phenomenon in which the radio frequency of the resonant cavity or a dark current is leaked externally or a high vacuum state is not reached because vacuum is not properly formed between the gasket and the housing can be prevented. Furthermore, a demand for high voltage and high vacuum can be satisfied because the performance of a particle accelerator is gradually improved. Furthermore, according to this construction, a resonant frequency within the resonant cavity can be precisely controlled although the size of the resonant cavity is not precisely fabricated from the beginning.

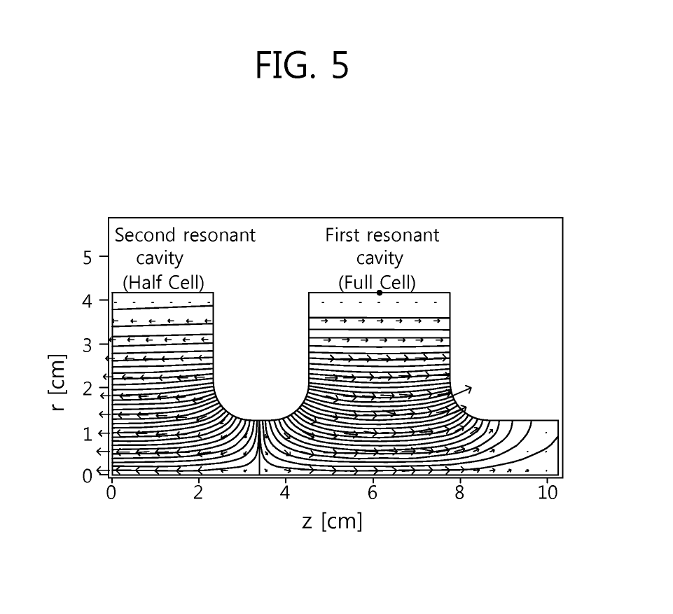

FIG. 5 is the results of simulation for a distribution of electric fields within the resonant cavity of the apparatus for generating an electron beam according to an embodiment of the present invention.

As shown in FIG. 5, the chart shows the results of electric fields within the resonant cavity which were measured by using SUPERFISH. In the chart, a horizontal axis indicates the distance from a face of the cathode 10 in the z-axis direction, and a vertical axis indicates the distance from the center of a face of the cathode 10 in an outward direction.

The resonant cavity includes the first resonant cavity (full cell) 51 and the second resonant cavity (half cell) 52. The length of the second resonant cavity 52 is 0.6 times the length of the first resonant cavity 51. In the present experiment, the apparatus for generating an electron beam was operated in the resonant frequency f_{π} of π-mode=2,856 MHz.

In the prior art, the resonant frequency of the full cell was controlled by using two tuning rods installed in a hole formed in the full cell. Furthermore, in order to control the resonant frequency of the half cell, the helicoflex seal was used. If this method is used, however, asymmetry was generated between an RF breakdown and an electric field.

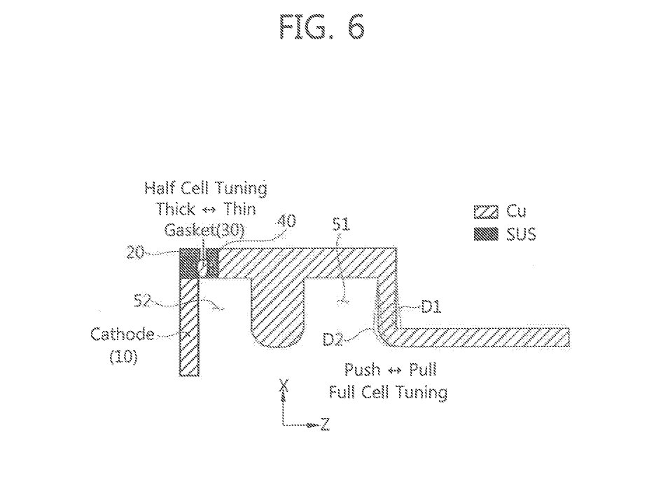

FIG. 6 is a side cross-sectional view showing a process of tuning a resonant frequency in the first resonant cavity and the second resonant cavity according to an embodiment of the present invention.

As can be seen from FIG. 6, in the present embodiment, in order to tune the resonant frequency of the first resonant cavity, the resonant frequency of the first resonant cavity may be changed by deforming the first resonant cavity in the z-axis direction. That is, a shape of the housing is changed by compressing or extending the housing in the axial direction, and thus a resonant frequency unique to the housing may be changed. A symbol D1 indicates a deformed shape of the housing when the housing is extended in the z-axis direction, and a symbol D2 indicates a deformed shape of the housing when the housing is compressed in a direction opposite to the z-axis direction. Meanwhile, in order to tune the resonant frequency of the second resonant cavity, the gasket 30 having a different thickness may be used.

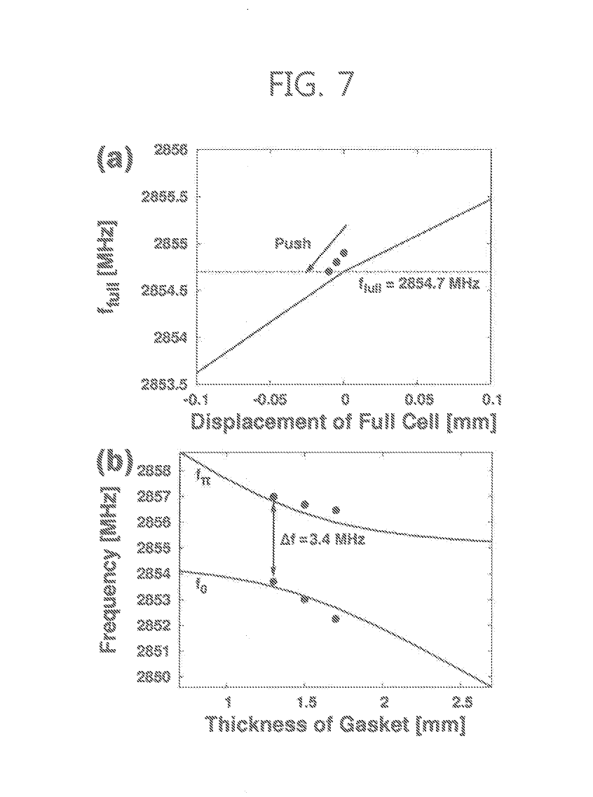

FIG. 7 is a graph showing experimental data and the results of simulation according to an embodiment of the present invention.

As can be seen from (a) of FIG. 7, dots indicate experimental data, and a solid line indicates the result of simulation. The resonant frequency k_{full} of the full cell may be controlled so that it becomes close to a target value by compressing the full cell. The resonant frequency k_{full} of the full cell was finally set to 2854.7 MHz. In the process of tuning the full cell, the wall of the full cell was deformed inside about 10 micrometers.

Next, the tuning of the half cell may be performed by using the metal gasket having a different size.

(b) of FIG. 7 shows that when a ratio of a maximum value of an accelerating electric field between the full cell and the half cell is 1, a difference Δf between the frequency of a π-mode and the frequency of a O-mode is 3.4 MHz. That is, when fᵤ, that is, the frequency of the π-mode, is 2,856.98 MHz when Δf is 3.4 MHz. The tuning of the full cell and the half cell was performed at 23.0° C.

Next, the resonant frequency is finally controlled by temperature tuning. When temperature was increased from 23.0° C. to 40.9° C., that is, common operating temperature, f_{π} reached 2,856.0 MHz when Δf was 3.4 MHz. A measured value was identical with the results of simulation indicated by the solid line.

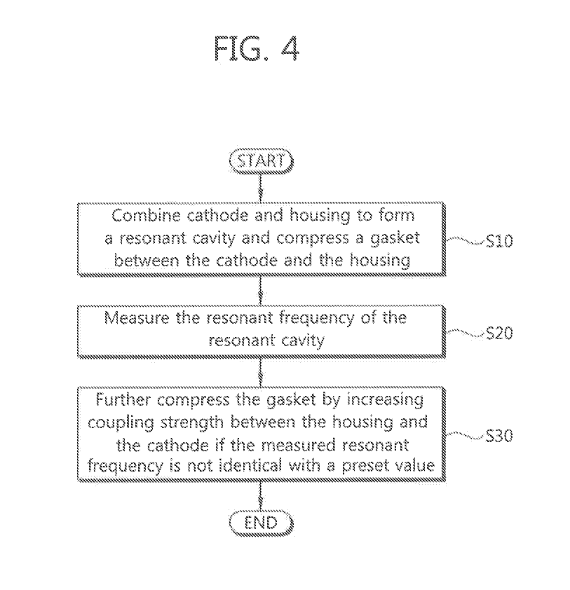

FIG. 4 is a flowchart illustrating a method of tuning a resonant frequency according to an embodiment of the present invention.

First, the gasket is placed between the housing flange and the cathode flange, and the housing flange and the cathode flange are combined by specific coupling strength using a bolt coupling method or a similar coupling method (S10 of FIG. 4).

Furthermore, vacuum is formed within the resonant cavity by vacuum through the pumping cavity.

Next, a resonant frequency within the resonant cavity is measured (S20 of FIG. 4). When the measured resonant frequency is smaller than a target frequency, coupling strength between the housing flange and the cathode flange is increased so that the gasket is further compressed. This is because the resonant frequency within the resonant cavity and the size of the resonant cavity are in inverse proportion to each other.

As another embodiment, if the measured resonant frequency is significantly greater than the target frequency, the gasket having a thicker thickness may be used. If the measured resonant frequency is significantly smaller than the target frequency, the gasket having a thinner thickness may be used.

Next, if the resonant frequency is measured again and the measured resonant frequency is less than the target frequency, the gasket may be further compressed by increasing coupling strength between the housing flange and the cathode flange (S30 of FIG. 4). There is an advantage in that the resonant frequency can be easily controlled through the above steps.

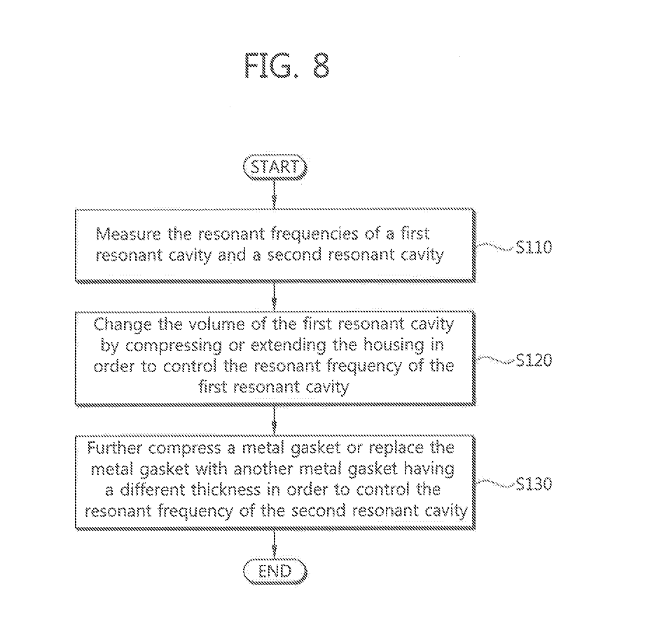

FIG. 8 is a flowchart illustrating a process of tuning a resonant frequency according to another embodiment of the present invention.

First, a step S110 of measuring the resonant frequencies of the first resonant cavity and the second resonant cavity may be performed. Next, a step S120 of changing the volume of the first resonant cavity by compressing or extending the housing in order to control the resonant frequency of the first resonant cavity may be performed. Next, a step S130 of further compressing the metal gasket or replacing the metal gasket with another metal gasket having a different thickness in order to control the resonant frequency of the second resonant cavity may be performed. The steps S130 and S120 may be reversed in order and performed.

There is an advantage in that the resonant frequency of the resonant cavity can be minutely controlled by using amount of compression of the gasket. Furthermore, there is an advantage in that the resonant frequency of the resonant cavity can be minutely controlled by inserting the gaskets of various thicknesses. Furthermore, there is an advantage in that a high vacuum state may be easily formed in the resonant cavity according to the construction of this gasket. Furthermore, there is an advantage in that RF contact becomes better because the metal gasket is used. Furthermore, there is an advantage in that the occurrence of an RF breakdown of the resonant cavity and a dark current is prevented.

Technical objects of the present invention are not limited to the above-described object and other technical objects that have not been described above will become evident to those skilled in the art from the following description.

The embodiments of the present invention described above and shown in the drawings should not be construed as limiting the technical spirit of the present invention. The scope of the present invention is restricted by only the claims, and a person having ordinary skill in the art to which the present invention pertains may improve and modify the technical spirit of the present invention in various forms. Accordingly, the modifications and modifications will fall within the scope of the present invention as long as they are evident to those skilled in the art.

What is claimed is:

1. An apparatus for generating an electron beam, comprising:
a housing configured to have a resonant cavity formed therein;
a cathode installed in an opening of the housing on one side so that an electron beam is generated from a surface of the cathode by a laser incident on an inside of the resonant cavity; and
a metal gasket installed between the cathode and the housing in order to seal the housing and compressed by coupling strength between the cathode and the housing so that a resonant frequency of the resonant cavity is controlled.

2. The apparatus as claimed in claim 1, wherein the metal gasket is made of oxygen-free copper.

3. The apparatus as claimed in claim 1, wherein the metal gasket is fabricated by cutting a metal plate in a ring form or fabricated in a ring form using a casting or forging method.

4. The apparatus as claimed in claim 1, wherein:
the resonant cavity includes a first resonant cavity and a second resonant cavity connected together, and
the first resonant cavity and the second resonant cavity are arranged in a direction where the electron beam generated from the cathode is emitted.

5. A method of manufacturing an apparatus for generating an electron beam, the method comprising:
combining a housing having a resonant cavity formed therein, a metal gasket, and a cathode;
measuring a resonant frequency of the resonant cavity of the housing with which the metal gasket and the cathode are combined; and
further compressing the metal gasket or replacing the metal gasket with another metal gasket having a different thickness if the measured resonant frequency is not identical with a set value.

6. A method of manufacturing an apparatus for generating an electron beam, the method comprising:
compressing a metal gasket between a cathode and a housing while combining the cathode and the housing;
measuring a resonant frequency of a resonant cavity within the housing; and
further compressing the metal gasket by increasing coupling strength of the cathode and the housing, if the measured resonant frequency is less than a set value, and replacing the metal gasket with another metal gasket having a thicker thickness, if the measured resonant frequency is greater than the set value.

7. A method of manufacturing an apparatus for generating an electron beam, comprising a housing configured to have a resonant cavity formed therein, a cathode installed in an opening of the housing on one side, and a metal gasket installed between the cathode and the housing, wherein the resonant cavity comprises a first resonant cavity and a second resonant cavity connected together, the method comprising:
measuring resonant frequencies of the first resonant cavity and the second resonant cavity;
changing a volume of the first resonant cavity by compressing or extending the housing in order to control the resonant frequency of the first resonant cavity; and
further compressing the metal gasket or replacing the metal gasket with another metal gasket having a different thickness in order to control the resonant frequency of the second resonant cavity.

8. The method as claimed in claim 5, wherein the metal gasket is provided by cutting a metal plate in a ring form or provided in a ring form using a casting or forging method.

9. A method of manufacturing an apparatus for generating an electron beam, comprising:
measuring a resonant frequency of a resonant cavity within a housing; and
deforming the housing by compressing or extending the housing in an axial direction if the measured resonant frequency is not identical with a set value.

10. The method as claimed in claim 6, wherein the metal gasket is provided by cutting a metal plate in a ring form or provided in a ring form using a casting or forging method.

11. The method as claimed in claim 7, wherein the metal gasket is provided by cutting a metal plate in a ring form or provided in a ring form using a casting or forging method.
